(19) United States
(12) Patent Application Publication
(10) Pub. No.: US 2009/0154433 A1
(43) Pub. Date: Jun. 18, 2009

(54) LOCAL AREA WIRELESS COMMUNICATION APPARATUS AND METHOD

(75) Inventors: Il-Soon JANG, Daejeon (KR); Seong-hee Lee, Daejeon (KR); Seong Hee Park, Daejeon (KR); Sangsung Choi, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/177,647

(22) Filed: Jul. 22, 2008

(30) Foreign Application Priority Data
Dec. 17, 2007 (KR) 10-2007-0132857

(51) Int. Cl. H04Q 7/24

(52) U.S. Cl. 370/338

(57) ABSTRACT

An apparatus and method for local area communication between Bluetooth and MBOA-MAC devices is provided. A new Bluetooth Protocol Adaptation Layer (PAL) is implemented to adapt a Bluetooth host module and an MBOA-MAC to each other so as to enable use of conventional legacy Bluetooth applications in a wireless network environment employing a WiMedia Multiband OFDM Alliance (MBOA)-based Media Access Control (MAC) layer. This allows devices equipped with a conventional Bluetooth host module to perform high-speed data communication based on MBOA-MAC, thereby increasing the efficiency of utilization of networks.

### CROSS-REFERENCE(S) TO RELATED APPLICATIONS

The present invention claims priority of Korean Patent Application No. 10-2007-0132857, filed on Dec. 17, 2007, which is incorporated herein by reference.

### FIELD OF THE INVENTION

The present invention relates to a local area wireless network, and more particularly to a Bluetooth and MBOA-MAC-based local area wireless communication apparatus and method which enables use of legacy Bluetooth applications in a wireless network environment employing a WiMedia Multiband Orthogonal Frequency Division Multiplexing Alliance (MBOA)-based Media Access Control (MAC) layer.

This work was supported by the IT R&D program of MIC/IITA. [2006-S-071-02, Development of UWB Solution for High Speed Multimedia Transmission]

### BACKGROUND OF THE INVENTION

Currently, Bluetooth is the most widely used among local area wireless communication protocols due to its low power consumption and low price thereof. For example, Bluetooth is used to wirelessly connect a PC and neighboring devices such as headphones, a keyboard, and a mouse. Bluetooth is also widely used for various other electronic devices such as wireless earphones of mobile phones.

However, Bluetooth is problematic in being unsuitable for a large amount of data transmission required for a printer or broadband connection environments due to its low data communication rates having a maximum data transfer rate of 1-2 Mbps.

FIG. 1 illustrates a protocol stack and interface structures of a conventional Bluetooth host and a conventional device module. As shown in FIG. 1, a Bluetooth host module 10 and a device module 12 are physically connected through a UART serial port or a USB bus. The Bluetooth host module 10, which will also be referred to as a “host” for short, controls the device module 12, which will also be referred to as a “device” for short, through a host controller interface 14.

For example, a host application 11 transfers a Host Controller Interface (HCI) inquiry command to a Link Manager (LM) 16 baseband Link Controller (LC) 18 of a Bluetooth device module 12 in order to search for other devices supporting the Bluetooth. Then, the LM 16 and the LC 18 search for other neighboring devices and transfer the search result to the host through an HCI inquiry event. A logical Link Control and Adaptation Protocol (L2CAP) 13 multiplexes various upper protocols according to communication specifications defined in the Bluetooth standard.

Recently, a WiMedia MBOA-MAC-based Ultra-Wideband (UWB) protocol, which enables high-speed data communication at 480 Mbps while supporting local area wireless communication, has been developed to overcome communication speed problems associated with local area wireless communication using Bluetooth. The UWB sends a weak radio signal using a frequency band of 3.1-10.6 GHz. The communication range of UWB is about 10 meters, similar to that of Bluetooth. However, since UWB consumes lower power and can connect between local electronic devices at a high speed, UWB is suitable not only for use in connection to a neighboring device by using a wireless USB using UWB but also for installation on a small device such as a PDA or a mobile phone.

FIG. 2 illustrates a MAC/PHY structure in a wireless network environment provided by a WiMedia MBOA-based MAC layer which will also be referred to as “MBOA-MAC,” wherein a Service Access Point (SAP) is defined for interfacing data transmission/reception between the MBOA-MAC and an upper layer or Device Management Entity (DME) 20.

The SAP serves as a channel through which data is transmitted and received to and from the upper layer protocol. Specifically, a MAC-SAP 22 provides a service enabling the upper layer protocol to transmit and receive data to and from a MAC sublayer and a MAC SubLayer Management Entity (MLME)-SAP 24 provides a service enabling the DME 20 to transmit and receive data to and from the MAC sublayer. In addition, a PHY-SAP 26 provides a service enabling the MAC to transmit and receive data to and from the physical layer and a Physical Layer Management Entity (PLME)-SAP 28 provides a service enabling the DME 20 to transmit and receive data to and from the physical layer.

### SUMMARY OF THE INVENTION

It is, therefore, an object of the present invention to provide a new protocol for transmission/reception of data between the conventional Bluetooth host module, and the MBOA-MAC using MAC-SAP and MLME-SAP in a wireless network environment employing a WiMedia MBOA-based MAC in which high-speed data communication is possible so that the new protocol enables adaptation of data transmission/reception between the Bluetooth host module and the MBOA-MAC device module. This new protocol is expected to allow devices equipped with a conventional Bluetooth host module to perform high-speed data communication based on MBOA-MAC, thereby significantly increasing the efficiency of utilization of networks.

In accordance with one aspect of the invention, a local area wireless communication apparatus connected to a host control interface that interfaces with a Bluetooth host module, includes a Bluetooth protocol adaptation unit for performing adaptation of data transmitted/received between the Bluetooth host module and a Multiband Orthogonal Frequency Division Multiplexing Alliance-Media Access Control (MBOA-MAC)-based device module.

The Bluetooth protocol adaptation unit includes a local processing unitprocessing unit for processing a local Host Controller Interface (HCI) command and event communicated between the Bluetooth host module and a local MBOA-MAC, a remote processing unitprocessing unit for processing a remote HCI command and event communicated between the Bluetooth host module and a peer MBOA-MAC located within a predetermined local range, and a MAC management unit for establishing a channel for transmission/reception of a HCI command packet and a HCI event packet, data between the Bluetooth host module and the local or the peer MBOA-MAC.

The Bluetooth protocol adaptation unit further includes a data transmission/reception unit for processing data transmitted/received between the Bluetooth host module and the local or the peer MBOA-MAC through the channel established by the MAC management unit.

When the local processing unitprocessing unit receives the local HCI command from the Bluetooth host module, the local processing unit transmits the received local HCI command to the local MBOA-MAC and transmits an HCI event, which is received from the local MBOA-MAC in response to the local HCI command, to the Bluetooth host module.

When the remote processing unit receives the remote HCI command from the Bluetooth host module, the remote processing unit searches for another peer MBOA-MAC-based Bluetooth host located within a predetermined local range, transmits the remote HCI command, receives an HCI event message from a corresponding MBOA-MAC in response to the remote HCI command and transmits the received HCI event message to the Bluetooth host module.

When the remote processing unit receives the remote HCI command, the remote processing unit receives allocated channel resources for communication with other peer MBOA-MACs located within a predetermined local range to the local MBOA-MAC and transmits an inquiry command packet, inquiring whether or not a corresponding host application employs Bluetooth, to each of said other peer MBOA-MACs to search for an MBOA-MAC-based Bluetooth device or host.

The remote processing unit analyzes an inquiry result packet, which is received from said other peer MBOA-MACs in response to the inquiry command packet, to check whether or not a host of each said other peer MBOA-MACs employs Bluetooth and then transmits an HCI event message containing a checked result to the Bluetooth host module.

When the HCI command received from the Bluetooth host module is a command for controlling operation of the local or the peer MBOA-MAC, the HCI command is processed through a MAC SubLayer Management Entity-Service Access Point (MLME-SAP) between the MAC management unit and the local or the peer MBOA-MAC.

When the HCI command received from the Bluetooth host module is a command for data transmission/reception through the local or the peer MBOA-MAC, the HCI command is processed through a MAC-SAP between the local processing unit and the local MBOA-MAC or the remote processing unit and the peer MBOA-MAC.

The MAC management unit establishes a Distributed Reservation Protocol (DRP) or a Prioritized Contention Access (PCA) channel with the local or the peer MBOA-MAC to handle transmission/reception of the HCI command packet from the Bluetooth host module and the HCI event packet from the MBOA-MAC.

The local processing unit processes the HCI command packet and the HCI command event packet which do not require the peer MBOA-MAC's information.

The remote processing unit processes the HCI command packet and the HCI command event packet which require the peer MBOA-MAC's information.

In accordance with another aspect of the invention, a local area wireless communication apparatus includes a Bluetooth host module, a host control interface connected to the Bluetooth host module, and a Bluetooth protocol adaptation unit connected to the host control interface for performing adaptation of data transmitted/received between the Bluetooth host module and an MBOA-MAC-based device module.

In accordance with still another aspect of the invention, a method for local area wireless communication in a Bluetooth and MBOA-MAC-based network environment, includes generating, at an upper Bluetooth host module, a control command for controlling operation of a lower MBOA-MAC-based device module, adapting the control command generated at the Bluetooth host module to an MBOA-MAC-based device protocol readable by the MBOA-MAC-based device module, and performing MBOA-MAC-based local area communication with a neighboring device according to the control command of the Bluetooth host module adapted to the MBOA-MAC-based device protocol.

The step of adapting the control command generated at the Bluetooth host module to the MBOA-MAC-based device protocol includes checking whether an HCI command packet received from the Bluetooth host module is a local HCI command or a remote HCI command, transmitting, when the received HCI command packet is the local HCI command, an HCI event packet, which is received from a local MBOA-MAC in response to the local HCI command, to the Bluetooth host module, searching, when the received HCI command packet is the remote HCI command, for a peer MBOA-MAC having a Bluetooth host among peer MBOA-MACs connected to the local MBOA-MAC and located in a predetermined local range, and handling transmission/reception of HCI command and event packets or data between the Bluetooth host module and the peer MBOA-MAC having the Bluetooth host found through the searching.

The step of searching for the peer MBOA-MAC having the Bluetooth host includes Receiving, when the received HCI command packet is the remote HCI command, channel resources for communication with other peer MBOA-MACs located within a predetermined local range to the local MBOA-MAC, transmitting an inquiry command packet, inquiring whether or not a corresponding host application employs Bluetooth, to each of the other peer MBOA-MACs, and analyzing an inquiry result packet received from the other peer MBOA-MACs in response to the inquiry command packet to search for the peer MBOA-MAC having the Bluetooth host.

In the step of transmitting the HCI event packet, a local HCI command and event packets or data are transmitted/received between the local MBOA-MAC and the Bluetooth host module through a DRP or PCA channel established between the local MBOA-MAC and the Bluetooth host module.

In the step of handling transmission/reception, the remote HCI command and the event packets or the data are transmitted/received between the peer MBOA-MAC and the Bluetooth host module through a DRP or PCA channel established between the peer MBOA-MAC and the Bluetooth host module.

When the HCI command received from the Bluetooth host module is a command for controlling operation of the local or the peer MBOA-MAC, the HCI command is processed through a MAC SubLayer Management Entity-Service Access Point (MLME-SAP).

When the HCI command received from the Bluetooth host module is a command for data transmission/reception through the local or the peer MBOA-MAC, the HCI command is processed through a MAC-SAP.

### BRIEF DESCRIPTION OF THE DRAWINGS

The above and other objects and features of the present invention will become apparent from the following description of embodiments given in conjunction with the accompanying drawings, in which:

FIG. 1 illustrates a protocol stack structure of a conventional Bluetooth protocol;

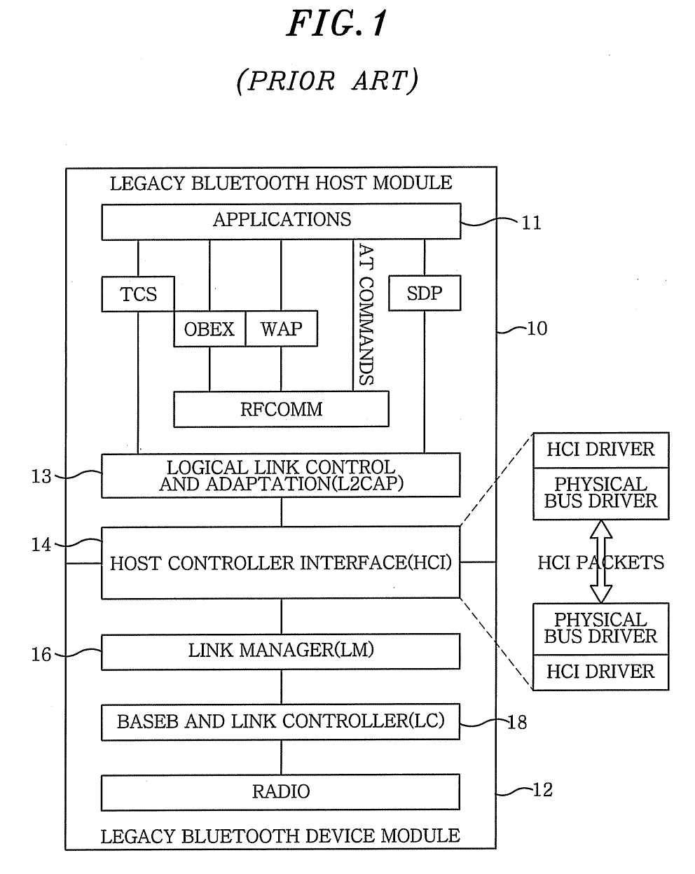

FIG. 2 describes a stack structure of a conventional MBOA-MAC;

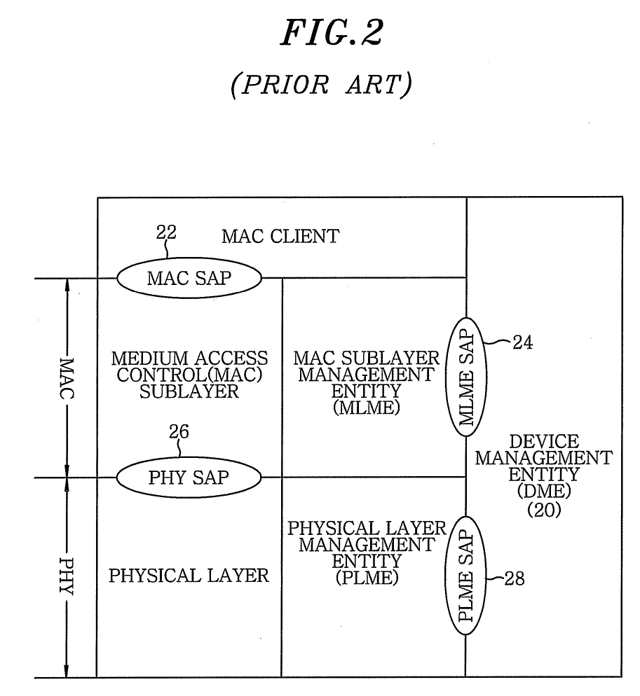

FIG. 3 shows a protocol structure adapting a Bluetooth host module and an MBOA-MAC according to an embodiment of the invention;

FIG. 4 offers a detailed protocol stack structure of a PAL that serves as a wireless communication adaptation device according to an embodiment of the invention; and

FIG. 5 depicts a process diagram illustrating how commands are communicated and executed between a Bluetooth module and an MBOA-MAC according to an embodiment of the invention.

### DETAILED DESCRIPTION OF THE EMBODIMENTS

The principles of the present invention will now be described with reference to the accompanying drawings. In the following description of the present invention, a detailed description of known functions and configurations incorporated herein will be omitted when it may obscure the subject matter of the present invention. The terms used in the following description were defined taking into consideration the functions obtained in accordance with the present invention. The definitions of these terms should be determined based on the whole content of this specification because they may be changed in accordance with the option of a user or operator or usual practice.

The main feature of the invention is that a Bluetooth protocol adaptation unit, which is also referred to as a Bluetooth Protocol Adaptation Layer (PAL), is implemented to adapt the MBOA-MAC and the Bluetooth host module to each other so that conventional legacy Bluetooth applications can be used in a wireless network environment employing the WiMedia MBOA-based MAC layer. The technology implementing the PAL can easily achieve the object of the invention.

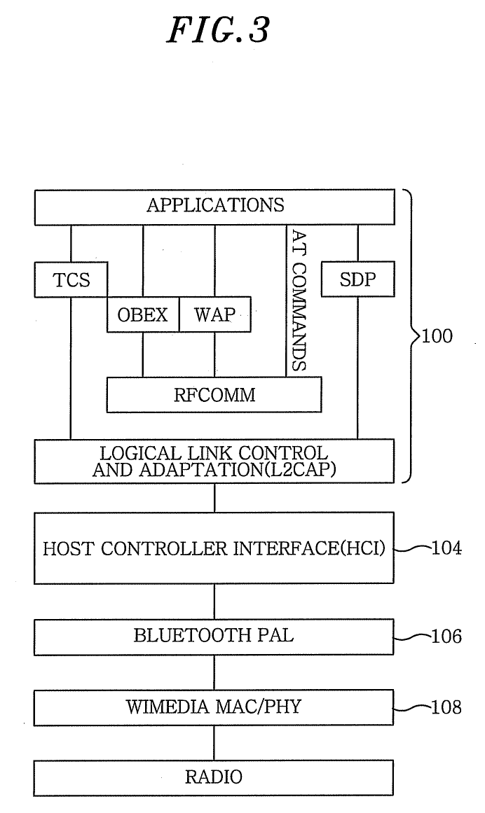

FIG. 3 illustrates a protocol stack structure of a local area wireless communication device for adapting a Bluetooth host module and an MBOA-MAC to each other according to an embodiment of the invention.

As shown in FIG. 3, when a conventional Bluetooth device module is replaced with a device module supporting the MBOA-MAC according to the invention, the device module needs a new layer which can perform functions of LM and LC of the conventional Bluetooth device module and interface with a MBOA-MAC 108. In the conventional Bluetooth module, one of the LC's functions provided to the upper layer is to detect and manage devices. Using this function, the Bluetooth host module 100 transfers an HCI inquiry command to the Bluetooth device module and the Bluetooth device module identifies the command and controls a lower layer to perform a corresponding operation.

Accordingly, the invention defines a new Bluetooth Protocol Adaptation Layer (PAL) 106 serving as a wireless communication adaptation device that analyzes an HCI packet received from the conventional Bluetooth host module 100 so as to control the MBOA MAC/PHY 108.

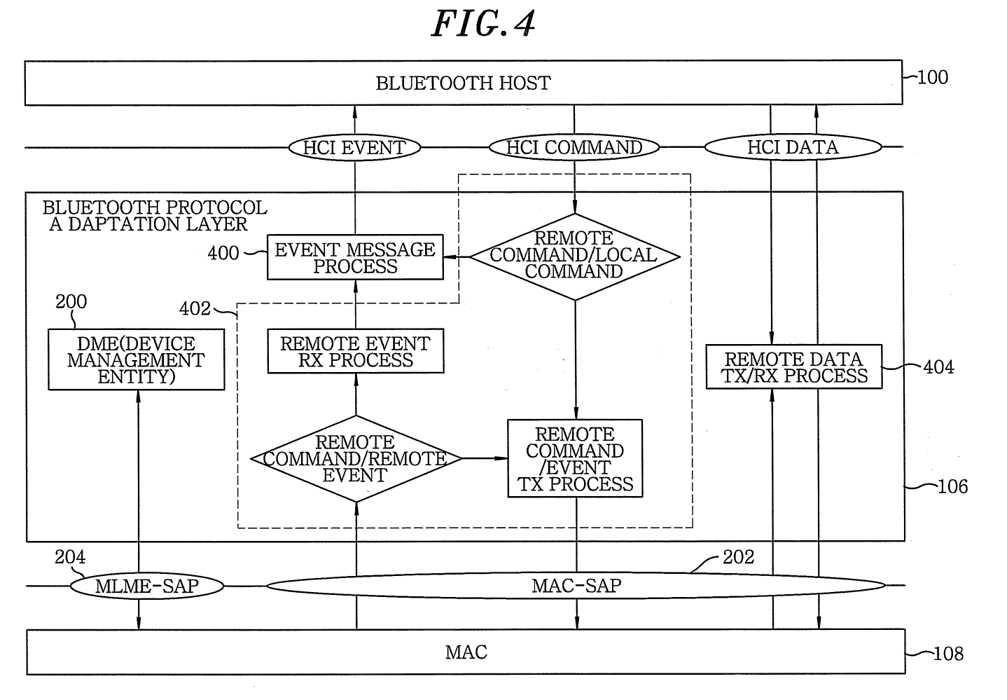

FIG. 4 illustrates a detailed protocol stack structure of a PAL 106 that serves as the wireless communication adaptation device according to the embodiment of the invention.

As shown in FIG. 4, interfaces of the PAL 106 use HCI commands, events, or data for interfacing with the conventional Bluetooth host module 100. On the other hand, the PAL 106 uses a MAC-SAP 202 and an MLME-SAP 204 provided by an MBOA-MAC 108 for interfacing with the MBOA-MAC 108.

The PAL 106 includes a local processing unit 400 for processing local HCI commands and events, a remote processing unit 402 for processing remote commands and events, a data transmission/reception unit 404 for processing data transmission and reception between the Bluetooth host module 100 and the MBOA-MAC 108, and a MAC management unit 200 for interfacing with the MBOA-MAC 108.

The following is a more detailed description of the components of the PAL 106. The local processing unit 400 processes local HCI commands and events communicated between the Bluetooth host module 100 and the local MBOA-MAC 108 and the remote processing unit 402 processes remote HCI commands and events communicated between the Bluetooth host module 100 and a peer MBOA-MAC (not shown) having a Bluetooth host located within a predetermined local range. The data transmission/reception unit 404 processes data transmitted and received between the Bluetooth host module 100 and the MBOA-MAC 108 or the peer MBOA-MAC.

The MAC management unit 200 establishes a channel for transmission and reception of HCI command and event packets or data between the Bluetooth host module 100 and the local MBOA-MAC 108 or the peer MBOA-MAC. To transfer data to an upper layer, the MBOA-MAC 108 mainly uses two transfer schemes, i.e., a Prioritized Contention Access (PCA) scheme and a Distributed Reservation Protocol (DRP) scheme. To transfer data and HCI command or event packets through the MLME-SAP 204 to MAC according these transfer schemes, it is necessary to perform a process for acquiring a DRP or PCA channel. This process is performed by the MAC management unit 200.

Conventional HCI inquiry commands are processed in the Bluetooth device module and inquiry result HCI events are transferred from the Bluetooth device module to the host. However, since not only Bluetooth applications but also various other applications such as 1394 and USB are provided, it is necessary to define a new protocol providing notification of whether or not each peer MBOA-MAC connected to the local MBOA-MAC 108 supports Bluetooth. In the invention, the PAL 106 checks whether each peer MBOA-MAC supports Bluetooth.

Here, the local processing unit 400, which serves to process local HCI commands/events, processes HCI commands and events which require no peer MBOA-MAC information and the remote processing unit 402, which serves to process remote commands/events, processes HCI commands and events which require peer MBOA-MAC information.

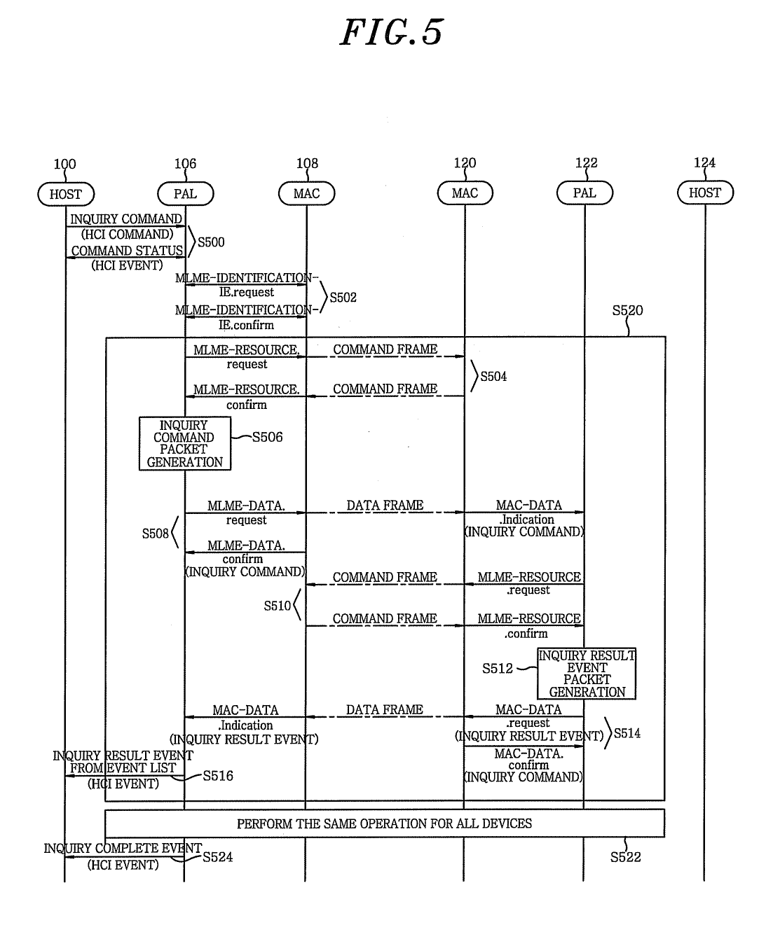

FIG. 5 illustrates a process diagram illustrating how an HCI inquiry command is executed when the conventional Bluetooth host sends an HCI inquiry command packet using the PAL 106 of FIG. 4 according to an embodiment of the invention.

As shown in FIG. 5, at step S500, when the Bluetooth host 100 transfers an HCI inquiry command packet to the PAL 106, the local processing unit 400 of the PAL 106 transfers an HCI command status event, indicating that it is necessary to temporarily wait the required time to execute a corresponding command, to both the Bluetooth host 100 and the MAC management unit 200 in response to the HCI inquiry command packet.

Then, at step S502, to execute the inquiry, the MAC management unit 200 of the PAL 106 generates and transfers an MLME-IDENTIFICATION-IE.request primitive, which requests information of neighboring devices, to the MBOA-MAC 108. Upon receiving the primitive, the MBOA-MAC 108 generates and transfers MLME-IDENTIFICATION-IE.confirm to the MAC management unit 200 of the PAL 106. Accordingly PAL 106 identifies neighboring peer MBOA-MACs 120 located within a predetermined local range at step S502 in this manner, and then determines whether or not each of the neighboring peer MBOA-MACs 120 is a Bluetooth device at step S520 in the manner described below.

In the case where the number of the neighboring peer MBOA-MACs 120 identified through the local MBOA-MAC 108 is N, step S520 is executed a total of N times. The PAL 106 transfers an HCI inquiry result event containing the result of the execution of step S520 to the Bluetooth host 100 at step S516. When the determination as to whether or not every peer MBOA-MAC is a Bluetooth device has been completed through the N executions of step S520, the PAL 106 finally transfers an HCI inquiry complete event to the Bluetooth host 100 at step S524.

Specifically, the step S520 determining whether or not each of the neighboring peer MBOA-MACs 120 located within a predetermined local range is a Bluetooth device includes the steps S504 and S510 acquiring a DRP or PCA channel with the MAC 108, the steps S506 and S512 generating remote HCI inquiry command and event packets, and the steps S508 and S514 transferring the generated packets through the acquired channel.

More specifically, when the PAL 106 identifies the local MBOA-MAC 108 through MLME-IDENTIFICATION-IE.request and MLME-IDENTIFICATION-IE.confirm at step S502, the PAL 106 gets allocated channel resources for communication with the peer MBOA-MAC 120 by sending and receiving MLME RESOURCE.request and confirm messages to and from the local MBOA-MAC 108 and acquires a DRP or PCA channel for communication with the peer MBOA-MAC 120 at step S504.

Then, the PAL 106 generates an inquiry command packet inquiring that whether or not the peer MBOA-MAC host or device module employs Bluetooth at step S506 and transfers the generated inquiry command packet to the peer MBOA-MAC 120 through the acquired DRP or PCA channel at step S508.

Upon receiving the inquiry command packet, a PAL 122 of the peer MBOA-MAC 120 also gets allocated channel resources for communication with the local MBOA-MAC 108 by sending and receiving MLME RESOURCE.request and confirm messages to and from the peer MBOA-MAC 120 and acquires a DRP or PCA channel for communication with the local MBOA-MAC 108 at step S510.

Then, the peer PAL 122 generates an inquiry result packet indicating whether or not its own host or device module employs Bluetooth at step S512 and transfers the inquiry result packet to the local MBOA-MAC 108 through the acquired DRP or PCA channel at step S514.

Then, the PAL 106 transfers the HCI inquiry result event to the Bluetooth host 100 to inform the Bluetooth host 100 whether or not the host or device module of the peer MBOA-MAC employs Bluetooth at step S516. In this manner, the Bluetooth host 100 can detect neighboring Bluetooth hosts or devices, thereby enabling high-speed data communication using the MBOA-MAC.

As is apparent from the above description, a local area wireless communication apparatus and method according to the invention has a variety of features and advantages. For example, a new Bluetooth Protocol Adaptation Layer (PAL) is implemented to adapt a Bluetooth host module and an MBOA-MAC to each other so as to enable use of conventional legacy Bluetooth applications in a wireless network environment employing a WiMedia Multiband OFDM Alliance (MBOA)-based Media Access Control (MAC) layer. This allows devices equipped with a conventional Bluetooth host module to perform high-speed data communication based on MBOA-MAC, thereby increasing the efficiency of utilization of networks.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A local area wireless communication apparatus connected to a host control interface that interfaces with a Bluetooth host module, the apparatus comprising:
a Bluetooth protocol adaptation unit for performing adaptation of data transmitted/received between the Bluetooth host module and a Multiband Orthogonal Frequency Division Multiplexing Alliance-Media Access Control (MBOA-MAC)-based device module.

2. The apparatus of claim 1, wherein the Bluetooth protocol adaptation unit includes:
a local processing unit for processing a local Host Controller Interface (HCI) command and event communicated between the Bluetooth host module and a local MBOA-MAC;
a remote processing unit for processing a remote HCI command and event communicated between the Bluetooth host module and a peer MBOA-MAC located within a predetermined local range; and
a MAC management unit for establishing a channel for transmission/reception of a HCI command packet and a HCI event packet, data between the Bluetooth host module and the local or the peer MBOA-MAC.

3. The apparatus of claim 2, wherein the Bluetooth protocol adaptation unit further includes a data transmission/reception unit for processing data transmitted/received between the Bluetooth host module and the local or the peer MBOA-MAC through the channel established by the MAC management unit.

4. The apparatus of claim 2, wherein, when the local processing unit receives the local HCI command from the Bluetooth host module, the local processing unit transmits the received local HCI command to the local MBOA-MAC and transmits an HCI event, which is received from the local MBOA-MAC in response to the local HCI command, to the Bluetooth host module.

5. The apparatus of claim 2, wherein, when the remote processing unit receives the remote HCI command from the Bluetooth host module, the remote processing unit searches for another peer MBOA-MAC-based Bluetooth host located within a predetermined local range, transmits the remote HCI command, receives an HCI event message from a corresponding MBOA-MAC in response to the remote HCI command and transmits the received HCI event message to the Bluetooth host module.

6. The apparatus of claim 5, wherein, when the remote processing unit receives the remote HCI command, the remote processing unit receives allocated channel resources for communication with other peer MBOA-MACs located within a predetermined local range to the local MBOA-MAC and transmits an inquiry command packet, inquiring whether or not a corresponding host application employs Bluetooth, to each of said other peer MBOA-MACs to search for an MBOA-MAC-based Bluetooth device or host.

7. The apparatus of claim 6, wherein the remote processing unit analyzes an inquiry result packet, which is received from said other peer MBOA-MACs in response to the inquiry command packet, to check whether or not a host of each said other peer MBOA-MACs employs Bluetooth and then transmits an HCI event message containing a checked result to the Bluetooth host module.

8. The apparatus of claim 2, wherein, when the HCI command received from the Bluetooth host module is a command for controlling operation of the local or the peer MBOA-MAC, the HCI command is processed through a MAC SubLayer Management Entity-Service Access Point (MLME-SAP) between the MAC management unit and the local or the peer MBOA-MAC.

9. The apparatus of claim 2, wherein, when the HCI command received from the Bluetooth host module is a command for data transmission/reception through the local or the peer MBOA-MAC, the HCI command is processed through a MAC-SAP between the local processing unit and the local MBOA-MAC or the remote processing unit and the peer MBOA-MAC.

10. The apparatus of claim 2, wherein the MAC management unit establishes a Distributed Reservation Protocol (DRP) or a Prioritized Contention Access (PCA) channel with the local or the peer MBOA-MAC to handle transmission/reception of the HCI command packet from the Bluetooth host module and the HCI event packet from the MBOA-MAC.

11. The apparatus of claim 2, wherein the local processing unit processes the HCI command packet and the HCI command event packet which do not require the peer MBOA-MAC's information.

12. The apparatus of claim 2, wherein the remote processing unit processes the HCI command packet and the HCI command event packet which require the peer MBOA-MAC's information.

13. A local area wireless communication apparatus comprising:
a Bluetooth host module;
a host control interface connected to the Bluetooth host module; and
a Bluetooth protocol adaptation unit connected to the host control interface for performing adaptation of data transmitted/received between the Bluetooth host module and an MBOA-MAC-based device module.

14. A method for local area wireless communication in a Bluetooth and MBOA-MAC-based network environment, the method comprising:
generating, at an upper Bluetooth host module, a control command for controlling operation of a lower MBOA-MAC-based device module;
adapting the control command generated at the Bluetooth host module to an MBOA-MAC-based device protocol readable by the MBOA-MAC-based device module; and
performing MBOA-MAC-based local area communication with a neighboring device according to the control command of the Bluetooth host module adapted to the MBOA-MAC-based device protocol.

15. The method of claim 14, wherein the step of adapting the control command generated at the Bluetooth host module to the MBOA-MAC-based device protocol includes:
checking whether an HCI command packet received from the Bluetooth host module is a local HCI command or a remote HCI command;
transmitting, when the received HCI command packet is the local HCI command, an HCI event packet, which is received from a local MBOA-MAC in response to the local HCI command, to the Bluetooth host module;
searching, when the received HCI command packet is the remote HCI command, for a peer MBOA-MAC having a Bluetooth host among peer MBOA-MACs connected to the local MBOA-MAC and located in a predetermined local range; and
handling transmission/reception of HCI command and event packets or data between the Bluetooth host module and the peer MBOA-MAC having the Bluetooth host found through the searching.

16. The method of claim 15, wherein the step of searching for the peer MBOA-MAC having the Bluetooth host includes:
Receiving, when the received HCI command packet is the remote HCI command, channel resources for communication with other peer MBOA-MACs located within a predetermined local range to the local MBOA-MAC;
transmitting an inquiry command packet, inquiring whether or not a corresponding host application employs Bluetooth, to each of the other peer MBOA-MACs; and
analyzing an inquiry result packet received from the other peer MBOA-MACs in response to the inquiry command packet to search for the peer MBOA-MAC having the Bluetooth host.

17. The method of claim 15, wherein, in the step of transmitting the HCI event packet, a local HCI command and event packets or data are transmitted/received between the local MBOA-MAC and the Bluetooth host module through a DRP or PCA channel established between the local MBOA-MAC and the Bluetooth host module.

18. The method of claim 15, wherein, in the step of handling transmission/reception, the remote HCI command and the event packets or the data are transmitted/received between the peer MBOA-MAC and the Bluetooth host module through a DRP or PCA channel established between the peer MBOA-MAC and the Bluetooth host module.

19. The method of claim 15, wherein, when the HCI command received from the Bluetooth host module is a command for controlling operation of the local or the peer MBOA-MAC, the HCI command is processed through a MAC SubLayer Management Entity-Service Access Point (MLME-SAP).

20. The method of claim 19, wherein, when the HCI command received from the Bluetooth host module is a command for data transmission/reception through the local or the peer MBOA-MAC, the HCI command is processed through a MAC-SAP.
